(19) United States
(12) Patent Application Publication
(10) Pub. No.: US 2011/0142233 A1
(43) Pub. Date: Jun. 16, 2011

(54) SERVER AND CAMERA FOR VIDEO SURVIELLANCE SYSTEM AND METHOD FOR PROCESSING EVENTS IN THE SAME SYSTEM

(75) Inventors: Young Sae KIM, Daejeon (KR); Yong-Sung JEON, Daejeon (KR); Moo Seop KIM, Daejeon (KR); Jong-Wook HAN, Daejeon (KR); GEONWOO KIM, Daejeon (KR); Jin Hee HAN, Daejeon (KR); Hong II JU, Daejeon (KR); SuGil CHOI, Daejeon (KR)

(73) Assignee: Electronics and Telecommunications Research Institute, Daejeon (KR)

(21) Appl. No.: 12/786,966

(22) Filed: May 25, 2010

(30) Foreign Application Priority Data
Dec. 14, 2009 (KR) 10-2009-0123769

(51) Int. Cl. H04N 7/18; H04N 7/167

(52) U.S. Cl. 380/200; 348/159; 348/E07.085

(57) ABSTRACT

A method for processing events in a server for a video surveillance system, includes: when the server detects occurrence of an event, transmitting a collection command to one or more cameras; analyzing specifications of the cameras, determining a set value for functions of cameras capable of processing the event, and transmitting a setting command to cameras; transmitting an execution command to the cameras, and processing and storing video data received from the cameras; and transmitting a completion command to the cameras, and completing the event processing. Each of the cameras including function units for performing different functions includes common frameworks which enable function units to perform the different function in a uniform manner.

### CROSS-REFERENCE(S) TO RELATED APPLICATION

The present invention claims priority of Korean Patent Application No. 10-2009-0123769, filed on Dec. 14, 2009, which is incorporated herein by reference.

### FIELD OF THE INVENTION

The present invention relates to a server and cameras for a video surveillance system and a method for processing events therein, and, more particularly, to a server and cameras for a video surveillance system and a method of processing events in the server and cameras for a video surveillance system, in which events can be processed using a common method without considering respective event processing methods for the respective cameras, thereby enabling efficient integrated management.

### BACKGROUND OF THE INVENTION

Video surveillance systems using cameras, generally and collectively called Closed-Circuit TeleVisions (CCTVs), have already been adopted and used as monitoring and surveillance methods in many fields.

Recently, conventional analog-type surveillance cameras are being gradually replaced by high-performance digital network cameras including video compression technology. Furthermore, so-called intelligent cameras including video recognition and encryption technology are on the rise as next generation technology, and the development of technology related to the intelligent cameras is becoming a big issue in the related market. A video surveillance system using intelligent cameras is configured such that intelligent cameras for acquiring video images can primarily recognize and analyze video images, unlike the conventional technology in which a server, such as a control server or a Digital Video Recorder (DVR) server, receives, stores and analyzes video images transmitted by existing cameras having only a simple video image acquisition function. It is possible to realize more efficient video surveillance by the cooperation between the intelligent cameras and the server.

In the meantime, in the conventional video surveillance system using intelligent cameras, the most important issue of interest is how to efficiently and accurately recognize a specific event, that is, an incident considered to be an abnormal situation, when the event occurs.

Meanwhile, from the point of view of the actual management of the video surveillance system, how to manage the system and efficiently process an event when the event occurs is also a very important issue. Furthermore, since cameras managed by a server may be products manufactured by different manufacturers and these heterogeneous cameras may have different specifications and different operational methods, a problem arises in that the individual control of the cameras for processing events is very inefficient from the point of view of the integrated management of all cameras.

### SUMMARY OF THE INVENTION

Therefore, the present invention provides an efficient scheme which, when a server controls one or more cameras related to an event in an integrated manner in order to process the event, provides an event processing module commonly applicable to respective cameras and can efficiently process the event using uniform procedures between the server and the cameras.

In accordance with a first aspect of the present invention, there is provided a method for processing events in a server for a video surveillance system, including: when the server detects occurrence of an event, transmitting a collection command to one or more cameras; analyzing specifications of the cameras, determining a set value for functions of cameras capable of processing the event, and transmitting a setting command to cameras; transmitting an execution command to the cameras, and processing and storing video data received from the cameras; and transmitting a completion command to the cameras, and completing the event processing.

Each of the cameras including function units for performing different functions includes common frameworks which enable function units to perform the different function in a uniform manner.

In accordance with a second aspect of the present invention, there is provided a method of processing events in a camera for a video surveillance system, including: in response to a collection command of a server, activating event processing mode, and transmitting a collection command response to the server; in response to a setting command of the server, setting the event processing mode, and transmitting a setting command response to the server; in response to an execution command of the server, executing the event processing mode, and transmitting processed video data as an execution command response to the server; in response to a completion command of the server, completing the event processing mode, and transmitting a completion command response.

Each of the cameras including function units for performing different functions further includes common frameworks which enable function units to perform the different function in a uniform manner.

In accordance with a third aspect of the present invention, there is provided a server for a video surveillance system, including an event processing application for processing events in the server; wherein the event processing application comprises a command processing unit for transmitting a collection command, a setting command, an execution command, and a determination command to cameras; and wherein the cameras including function units for performing different functions further includes common frameworks which enable function units to perform the different function in a uniform manner.

In accordance with a fourth aspect of the present invention, there is provided a camera for a video surveillance system, including an event processing module for processing events in the camera; wherein the event processing module comprises a command processing unit for receiving a command from a server, a function unit for performing a video compression function, a video recognition function or a video encryption function in response to the command, and a common framework for connecting the command processing unit and the function unit to each other; and wherein the common framework is installed in the heterogeneous cameras including function units for performing different functions and enables function units to perform the different function in a uniform manner.

### BRIEF DESCRIPTION OF THE DRAWINGS

The above and other objects and features of the present invention will become apparent from the following description of preferred embodiments given in conjunction with the accompanying drawings, in which:

FIG. 1 is a diagram showing a video surveillance system in accordance with the present invention;

FIG. 2 is a diagram showing a process of processing events in a server and camera for a video surveillance system in accordance with the present invention; and

FIGS. 3A and 3B are block diagrams showing the server and camera for a video surveillance system in accordance with the present invention.

### DETAILED DESCRIPTION OF THE EMBODIMENTS

Hereinafter, the operational principle of the present invention will be described in detail with reference to the accompanying drawings which form a part hereof.

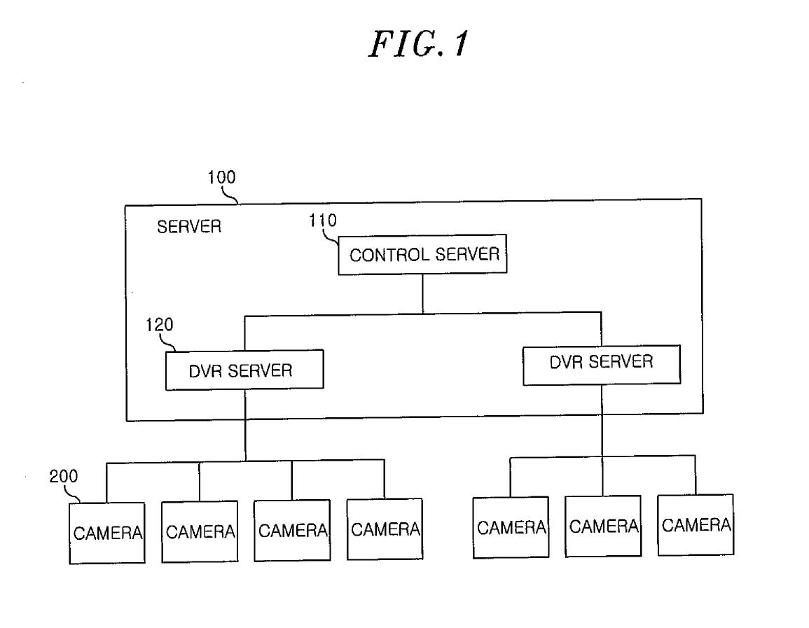

FIG. 1 shows a video surveillance system in accordance with an embodiment of the present invention. Referring to FIG. 1, the video surveillance system includes a server 100 and network cameras 200. The server 100 includes a control server 110 and a DVR (Digital Video Recorder) server 120.

The control server 110 performs a surveillance management function based on a GUI (Graphical User Interface) including a camera map. Further, the DVR server 120 performs functions including operating in conjunction with the cameras 200 and the processing and storing of video data. The control server 110 and the DVR server 120 may be configured such that a control server 110 is provided with respect to one or more DVR servers 120 and may be configured in various forms, such as an integrated server.

The network cameras 200 are intelligent cameras, and function to acquire and process video images.

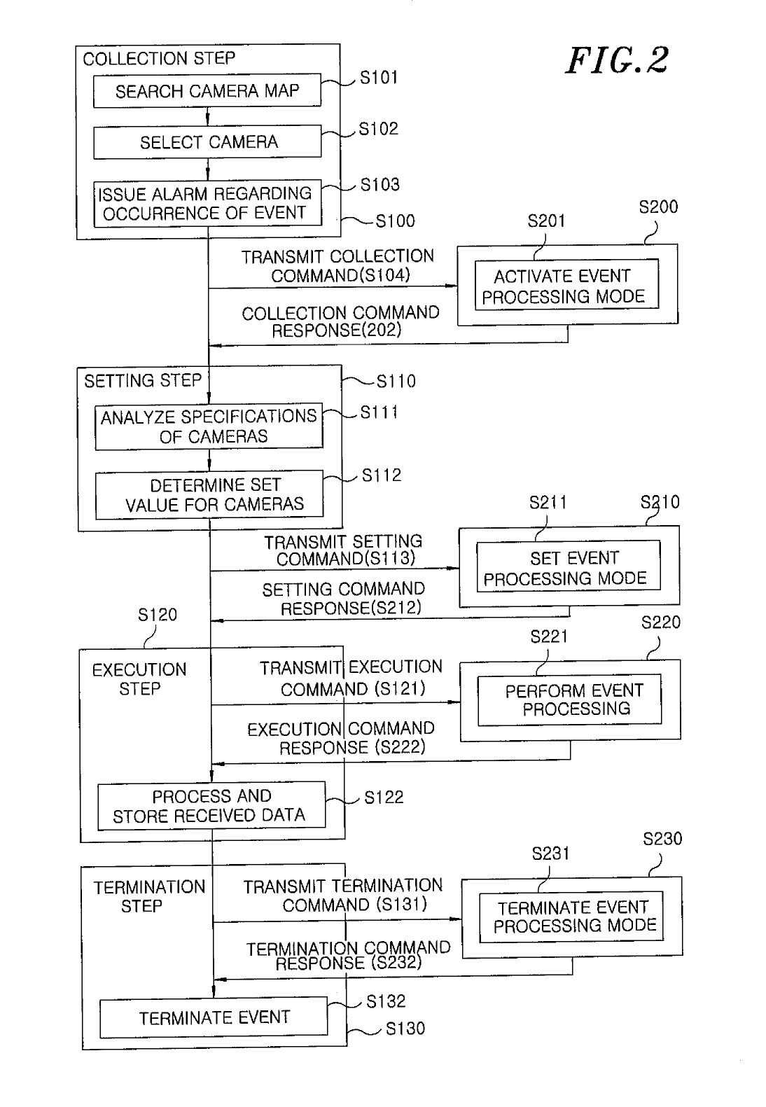

FIG. 2 shows a process of event processing in a server and camera for a video surveillance system in accordance with the present invention.

First, when the server 100 recognizes occurrence of an event, the server 100 proceeds to a collection step S100 by executing an event processing application. The server 100 recognizes the occurrence of an event in various forms, e.g., notification of event occurrence from a network camera 200, the detection of video transmitted from the network camera 200, and the provision of information from the outside, the information revealing a visit of a very important person or tracking of a criminal.

The collection step S100 is divided into the following detailed steps. First, in the collection step S100, the server 100 searches a camera map, including information of locations and types of installed camera 200 to request event processing to the related cameras 200 which are generally located in a specific area at step S101.

Thereafter, the server 100 selects related cameras by searching the camera map at step S102, and notifies the selected cameras 200 of a collection command for event processing to them at step S103.

Each of the cameras 200 received the collection command enters into event processing mode to process the specific event, executes an operation for the event processing, and first proceeds to a collection at step S200. At the collection step S200, the camera 200 activates the event processing mode by initializing the operations of various types of main functions for event processing such as video compression, video encryption and video recognition. The camera 200 completed the collection step S200 transmits a collection command response at step S202 to notify the server 100 of the completion of the operation with respect to the collection command.

The server 100 received the response enters into a setting step at S110. Set values for each of the cameras 200 vary depending on a type of a current event or the importance of a current event, such as an emergency class. Therefore, in the setting step S110, the server 100 analyzes the specifications of the respective cameras 200 in order to set the type of operating methods of the respective cameras 200 at step S111. Here, the set values include request parameter values for the main functions of the respective cameras 200, i.e., variable values related to a video compression function such as a codec type, resolution and speed, variable values related to a video encryption function such as an encryption method or crypto-complexity, and a value related to a video recognition function such as target object information. A method by which the server 100 detects the specifications of each of the cameras 200 may include a method using a camera map having all information about the cameras 200 or a method in which the camera 200 provides the specifications to the server 100 through the collection command response at step S202. After the specifications of each camera 200 have been analyzed at step S111, set values required for a current event are determined at step S112, and each camera 200 is requested to perform setting with the set values by transmitting a setting command to each camera 200 at step S113. In this case, since specifications supported by the respective cameras 200 are different, values suitable for an event are determined for each of the cameras 200 to be transmitted.

The camera 200 received the setting command enters into a setting command processing at step S210, and sets event processing mode by setting the received set values as parameter values for the operation of main functions. The camera 200 completed the setting at step S210 transmits a setting command response S212 to notify the server 100 of the completion of the processing with respect to the setting command.

The server 100 received the setting command response enters into an execution at step S120. In the execution step S120, the server 100 can confirm that each camera 200 has completed preparation for event processing at the previous steps, and requests each camera 200 to perform event processing by transmitting an execution command at step S121.

The camera 200 received the execution command enters into an execution command processing at step S220, and performs event processing by performing respective main functions in a preset manner. That is, in the event processing execution, a video recognition function performs video recognition and analysis function using a set target object, and a video encryption function performs encryption of a video image according to a set encryption method and the crypto-complexity. Meanwhile, a video compression function performs video compression according to a set codec and set resolution. The video data processed as described above is transmitted to the server 100 through an execution command response at step S222. Since the transmission of the execution command response S222 is the transmission of video data, the transmission is continuously and persistently performed in compliance with a video data transmission protocol, such as RTP or TCP/IP, previously agreed between the server 100 and the camera 200.

The server 100 received the execution command response S222 receives video data, and monitors the video data in real time or stores the video data as evidence at step S122. At this time the server 100 processes the received data in a manner corresponding to that of the camera 200 at step S122. That is, in the case of the video recognition function, additional analysis using a target object is performed, in the case of video encryption, decryption corresponding to the encryption used is performed, and, in the case of video compression, decoding corresponding to the type of codec used in encoding is performed. Meanwhile, since execution command responses S222 used to transmit the video data of the camera 200 are continuously and persistently transmitted as described above, the processing and storage of the received data is also performed continuously and persistently at step S122.

Finally, in order to complete the event, the server 100 enters into a completion mode at step S130, and transmits a completion command to the camera 200 at step S131.

The camera 200 received the completion command enters into the completion mode at step S230. In step S230, the camera 200 completes the event processing mode by completing the main functions, such as video compression, video encryption and video recognition, involved in event processing, and transmits a completion command response at step S232 to notify the server 100 of the completion of the processing with respect to the completion command. In this case, the camera 200 returns to basic mode which is present prior to the event processing mode.

The server 100 having received completion command responses from related cameras checks whether all of the received event processing has been normally completed and completes the event at step S132.

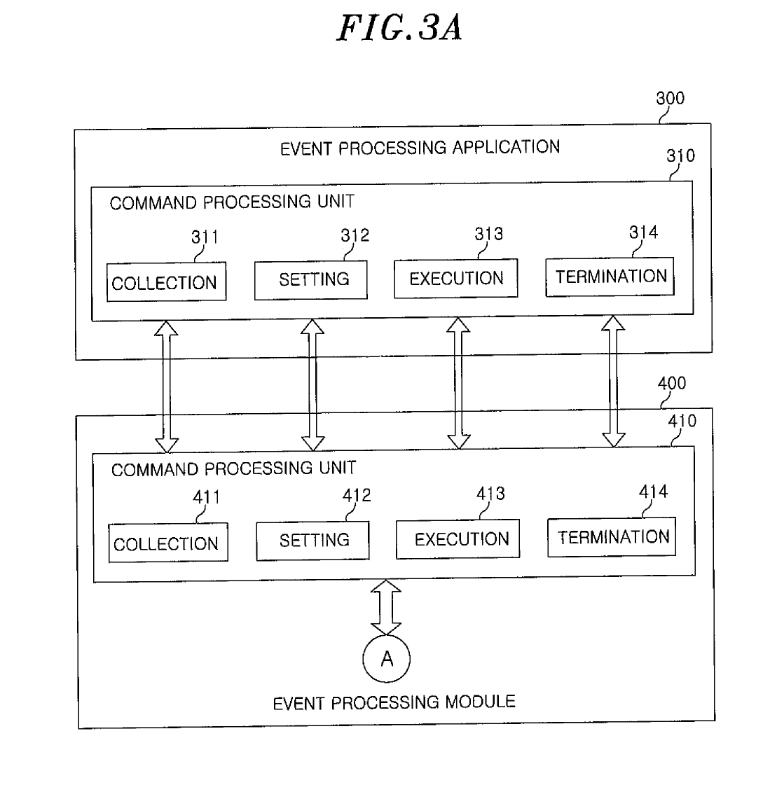

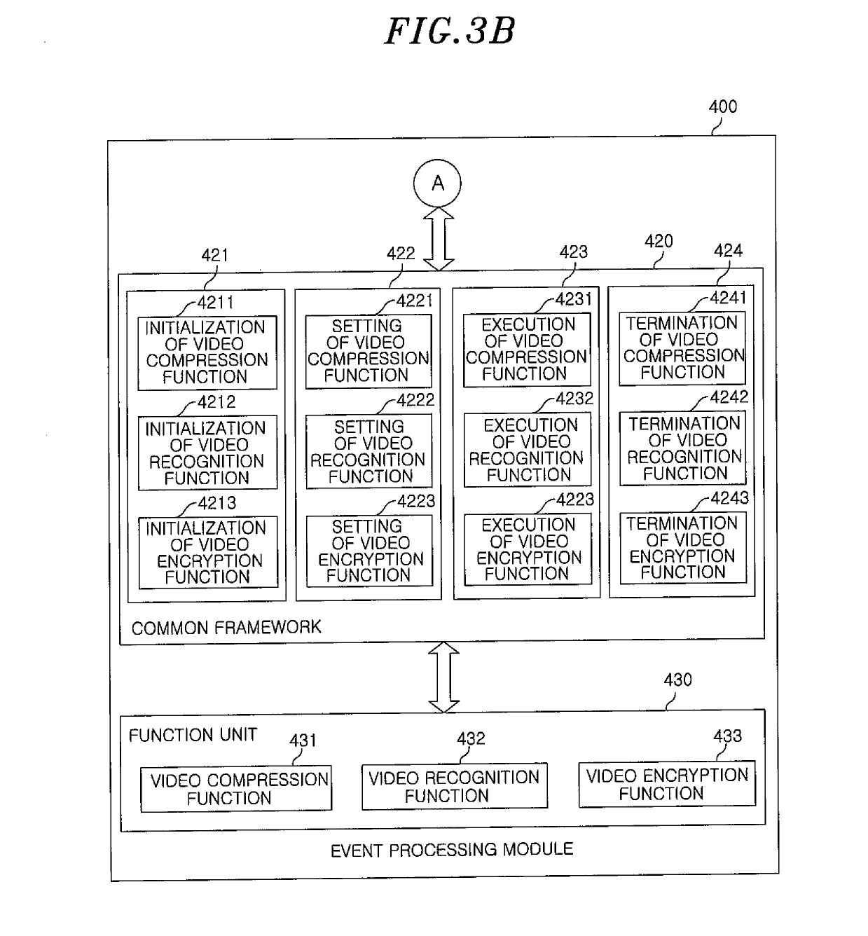

FIGS. 3A and 3B are block diagrams showing the server 100 and camera 200 of a video surveillance system in accordance with the embodiment of the present invention. Referring to FIG. 3A, the event processing application 300 in the server 100 includes a command processing unit 310. Further, the event processing module 400 in the camera 200 includes a command processing unit 410, a common framework layer 420, and a function unit 430, as shown in FIGS. 3A and 3B.

First, the event processing application 300 in the server 100 refers to the highest application for processing events. The event processing application 300 transmits a command to event processing module 400 at each of the steps of the collection step S100, the setting step S110, the execution step S120 and the completion step S130 to request execution of command. An operation of creating and transmitting the command is performed by the command processing unit 310. The command processing unit 310 includes a collection command unit 311, setting command unit 312, execution command unit 313 and completion command unit 314 to generate commands, which correspond to the four respective steps.

The commands transmitted as described above are received by the command processing unit 410 in the event processing module 400, are respectively processed by four subordinate processing units, including a collection processing unit 411, a setting processing unit 412, an execution processing unit 413, and a completion processing unit 414. Thereafter, an operation related to each of the four commands is performed in a layer lower than that of the command processing unit 410. When the operation related to each command has been performed, the command processing unit 410 transmits a response to the command processing unit 310 in the event processing application 300. That is, the command processing unit 310 in the event processing application 300 and the command processing unit 410 in the event processing module 400 function as a kind of Application Programming Interface (API) which provides a connection between functions of the event processing module 400 and the event processing application 300 thereby executing the commands of the event processing application 300.

When the operation of a specific step is requested by the command processing unit 410, the event processing module 400 performs the operation of each of main functions for processing events, such as video compression, video encryption and video recognition according to the respective steps. These main functions, such as a video compression function 431, a video recognition function 432 and a video encryption function 433, are provided to each of the cameras 200 in various forms, such as hardware, source code or libraries. Therefore, these functions may be defined as a single layer called a function unit 430, which is located in the lowest layer of the event processing module 400.

Meanwhile, different types of function units 430 are provided to the cameras 200 as described above. In this case, since individual event processing methods may be applied to each of the cameras 200, the server 100 needs to control the cameras 200 individually which is inefficient.

Although, in the present invention, in order to solve the problem, the event processing application 300 in the server 100 and the event processing module 400 in the camera 200 follow predetermined procedures based on four types of defined command processing by collection command unit 311-collection processing unit 411, setting command unit 312-setting processing unit 412, execution command unit 313-execution processing unit 413, and completion command unit 314-completion processing unit 414. For this purpose, a single layer, which enables operations to be effectively performed using different function units 430 by connecting the different function units 430 to the command processing unit 410, can be applied to all of the cameras 200 in common is required. This layer is the layer of a common framework 420.

This common framework 420 is divided into four subordinate frameworks including a collection framework 421, a setting framework 422, an execution framework 423, and a completion framework 424, corresponding to the respective commands. Each of the subordinate frameworks, in turn, are divided into components for the functions provided by the function unit 430. The collection framework 421 is divided into a video compression function initiation component 4211, a video recognition function initiation component 4212 and a video encryption function initiation component 4213, the setting framework 422 is divided into a video compression function setting component 4221, a video recognition function setting component 4222 and a video signal encryption function setting component 4223, the execution framework 423 is divided into a video compression execution component 4231, a video recognition execution component 4232 and a video encryption execution component 4233, and the completion framework 424 is divided into a video compression function completion component 4241, a video recognition function completion component 4242, and a video encryption function completion component 4243. The design of the common framework 420 is applied to all of the cameras 200 in the same manner, and is implemented for each of the cameras 200 in accordance with each function unit.

The server and camera for the video surveillance system and the method for processing the events of the server and camera in the video surveillance system in accordance with the embodiments of the present invention have the following advantage.

In accordance with the present invention, a common framework is provided for cameras having different types of function units and then the functions units are controlled using the same method, so that events can be processed using the common method without considering respective event processing methods for the cameras, with the result that event processing between the server and the cameras is performed as if a single application were executed on a single platform, thereby enabling efficient integrated management.

While the invention has been shown and described with respect to the preferred embodiments, it will be understood by those skilled in the art that various changes and modifications may be made without departing from the spirit and scope of the invention as defined in the following claims.

What is claimed is:

1. A method for processing events in a server for a video surveillance system, comprising:
when the server detects occurrence of an event, transmitting a collection command to one or more cameras;
analyzing specifications of the cameras, determining a set value for functions of cameras capable of processing the event, and transmitting a setting command to cameras;
transmitting an execution command to the cameras, and processing and storing video data received from the cameras; and
transmitting a completion command to the cameras, and completing the event processing;
wherein each of the cameras including function units for performing different functions includes common frameworks which enable function units to perform the different function in a uniform manner.

2. The method of claim 1, wherein the common framework initializes, sets, executes and completes each of a video compression function, a video recognition function and a video encryption function.

3. The method of claim 1, wherein said transmitting a collection command comprises searching a camera map to process the event when the occurrence of the event is detected.

4. The method of claim 1, wherein the server detects the occurrence of the event by notification of event occurrence by the cameras, by recognition of a video image transmitted from the cameras, or by information about the occurrence of the event by an information source other than either the server or the cameras.

5. The method of claim 1, wherein the set value for the functions of the cameras comprises one or more of a codec type, resolution, speed, an encryption method, a crypto-complexity, and target object information.

6. The method of claim 1, wherein the received video data is transmitted by using a video data transmission protocol previously agreed between the server and the cameras.

7. A method of processing events in a camera for a video surveillance system, comprising:
in response to a collection command of a server, activating event processing mode, and transmitting a collection command response to the server;
in response to a setting command of the server, setting the event processing mode, and transmitting a setting command response to the server;
in response to an execution command of the server, executing the event processing mode, and transmitting processed video data as an execution command response to the server;
in response to a completion command of the server, completing the event processing mode, and transmitting a completion command response;
wherein each of the cameras including function units for performing different functions further includes common frameworks which enable function units to perform the different function in a uniform manner.

8. The method of claim 7, wherein the common framework initializes, sets, executes and completes each of a video compression function, a video recognition function and a video encryption function.

9. The method of claim 7, wherein a set value for the event mode includes one or more of a codec type, resolution, speed, an encryption method, a crypto-complexity and target object information.

10. The method of claim 7, wherein the transmitted video data is processed using a video data transmission protocol previously agreed between the server and the cameras.

11. A server for a video surveillance system, comprising an event processing application for processing events in the server;
wherein the event processing application comprises a command processing unit for transmitting a collection command, a setting command, an execution command, and a determination command to cameras; and
wherein the cameras including function units for performing different functions further includes common frameworks which enable function units to perform the different function in a uniform manner.

12. The server of claim 11, wherein the common framework comprising:
a collection framework for performing an initialization function;
a setting framework for setting a video compression function, a video recognition function or a video encryption function;
an execution framework for performing the video compression function, the video recognition function or the video encryption function; and
a completion framework for completing the video compression function, the video recognition function or the video encryption function.

13. The server of claim 11, wherein when the occurrence of the event is detected, the server searches a camera map to process the event, and transmits the collection command to one or more cameras.

14. The server of claim 13, wherein the detection of the occurrence of the event is achieved by notification of event occurrence by the cameras, by recognition of a video image transmitted from the cameras, or by information about the occurrence of the event by an information source other than either the server or the cameras.

15. The server of claim 11, wherein a set value for functions of the cameras comprises one or more of a codec type, resolution, speed, an encryption method, a crypto-complexity, and target object information.

16. The server of claim 11, wherein video data obtained by each of the cameras is transmitted to the server by using a video data transmission protocol previously agreed between the server and the cameras.

17. A camera for a video surveillance system, comprising an event processing module for processing events in the camera;
wherein the event processing module comprises a command processing unit for receiving a command from a server, a function unit for performing a video compression function, a video recognition function or a video encryption function in response to the command, and a common framework for connecting the command processing unit and the function unit to each other; and
wherein the common framework is installed in the heterogeneous cameras including function units for performing different functions and enables function units to perform the different function in a uniform manner.

18. The camera of claim 17, wherein the common framework comprising:
a collection framework for performing an initialization function;
a setting framework for setting a video compression function, a video recognition function or a video encryption function;
an execution framework for performing the video compression function, the video recognition function or the video encryption function; and
a completion framework for completing the video compression function, the video recognition function or the video encryption function.

19. The camera of claim 18, wherein a set value set by the setting framework includes one or more of a codec type, resolution, speed, an encryption method, a crypto-complexity, and target object information.

20. The camera of claim 18, wherein video data processed by the execution framework is transmitted to the server using a video data transmission protocol previously agreed between the server and the cameras.
